(19) United States
(12) Patent Application Publication
(10) Pub. No.: US 2016/0292794 A1
(43) Pub. Date: Oct. 6, 2016

(54) ELECTRONIC GOAL MONITORING

(71) Applicant: Jeffrey C. SEDAYAO, San Jose, CA (US)

(72) Inventor: Jeffrey C. SEDAYAO, San Jose, CA (US)

(21) Appl. No.: 15/037,441

(22) PCT Filed: Dec. 20, 2013
(86) PCT No.: PCT/US2013/077089

§ 371 Date: May 18, 2016

(51) Int. Cl. G06Q 50/00; G06F 17/30

(52) U.S. Cl. CPC G06Q 50/01; G06F 17/30864

(57) ABSTRACT

Technologies for electronically monitoring achievement of goals includes a goal achievement computing device that receives section of a goal related to an online presence of a user. The goal achievement computing device indexes online content related to the selected goal and analyzes the indexed online content based on a goal database. The goal database includes conditions that hinder achievement and support achievement of the selected goal. The goal achievement computing device determines a recommendation for achieving the selected goal based on a determination that a portion of the indexed online content satisfies a condition that hinders or a condition supports achievement of the selected goal.

### BACKGROUND

The Internet has become a ubiquitous tool for personal, business, and social uses and, as a result, it is becoming an increasingly popular way for people to communicate with each other. This is partly due to the fact that communicating over the Internet is typically a quicker and more economical method of communicating than traditional forms of communications such as, for example, conventional telephone networks and the postal system. Additionally, the increasing availability of more affordable computing devices and options for connecting to the Internet only serves to make online communications more popular to users.

Social media and other types of online media (e.g., product review websites, blogs, news feeds, etc.) are increasingly popular platforms for online communications. For example, many Internet users choose to be members of a social networking community, which enables those users to communicate within one or more social or professional groups of users. Other users choose to post information on a website or a blog regarding their personal views and/or activities (e.g., a product review, an op-ed, a personal gripe regarding a person or a business, vacation photos, etc.). Oftentimes, a user's online communications (e.g., social networking posts, website posts, etc.) are publically available. As a result, users are increasingly becoming aware that the information they post online can have a profound impact on their personal and professional reputation, both on the Internet and in the real world.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for electronically monitoring achievement of goals related to an online presence of a user;

FIG. 2 is a simplified block diagram of at least one embodiment of an environment of a goal achievement server of the system of FIG. 1;

FIG. 3 is a simplified block diagram of at least one embodiment of an environment of a computing device of the system of FIG. 1;

FIG. 4 is a simplified flow diagram of at least one embodiment of a method for monitoring achievement of goals that may be executed by the goal achievement server of the system of FIG. 1;

FIG. 5 is an illustrative embodiment of a goal database that may be used by the goal achievement server of the system of FIG. 1 for monitoring goal achievement;

FIG. 6 is a simplified flow diagram of at least one embodiment of a method for generating recommendations related to content to be posted online that may be executed by the goal achievement server of the system of FIG. 1; and

FIG. 7 is a simplified flow diagram of at least one embodiment of a method for receiving recommendations from the goal achievement server that relate to content to be posted online that may be executed by the computing device of the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

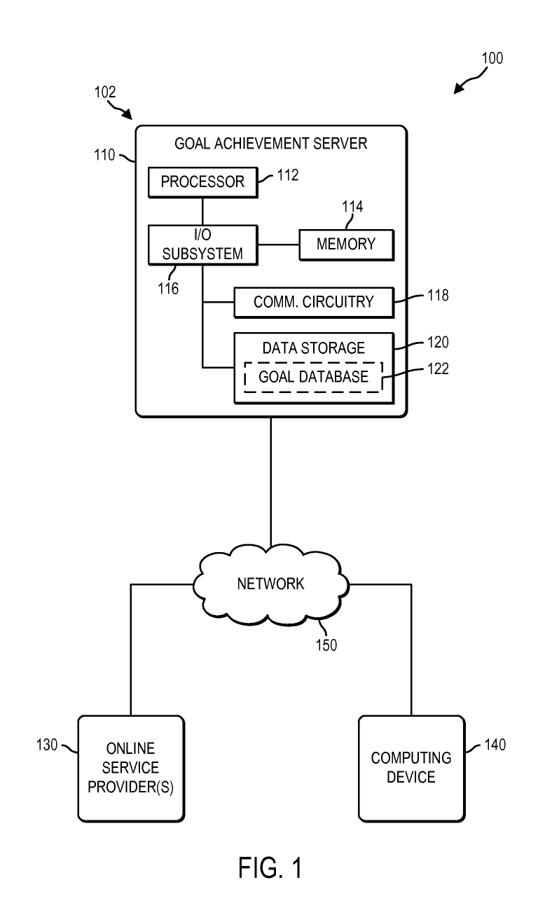

Referring now to FIG. 1, in an illustrative embodiment, a system 100 for electronically monitoring achievement of one or more goals to be achieved by a user includes a goal achievement computing device 102, one or more online service providers 130, and a computing device 140, which communicate with each other over a network 150. In the illustrative embodiment shown in FIG. 1, the goal achievement computing device 102 is embodied as a goal achievement server 110. It should be appreciated, however, that although the goal achievement computing device 102 is described herein as being embodied as a server computing device 110 as shown in FIG. 1, the goal achievement computing device 102 may be embodied as, or otherwise included in, any other type of computing device or end user device. For example, in some embodiments the functionality and features of the goal achievement computing device 102 may be included in the computing device 140. That is, in such embodiments, the computing device 140 may include all of the functionality described herein with regard to the computing device 140 and the goal achievement computing device 102.

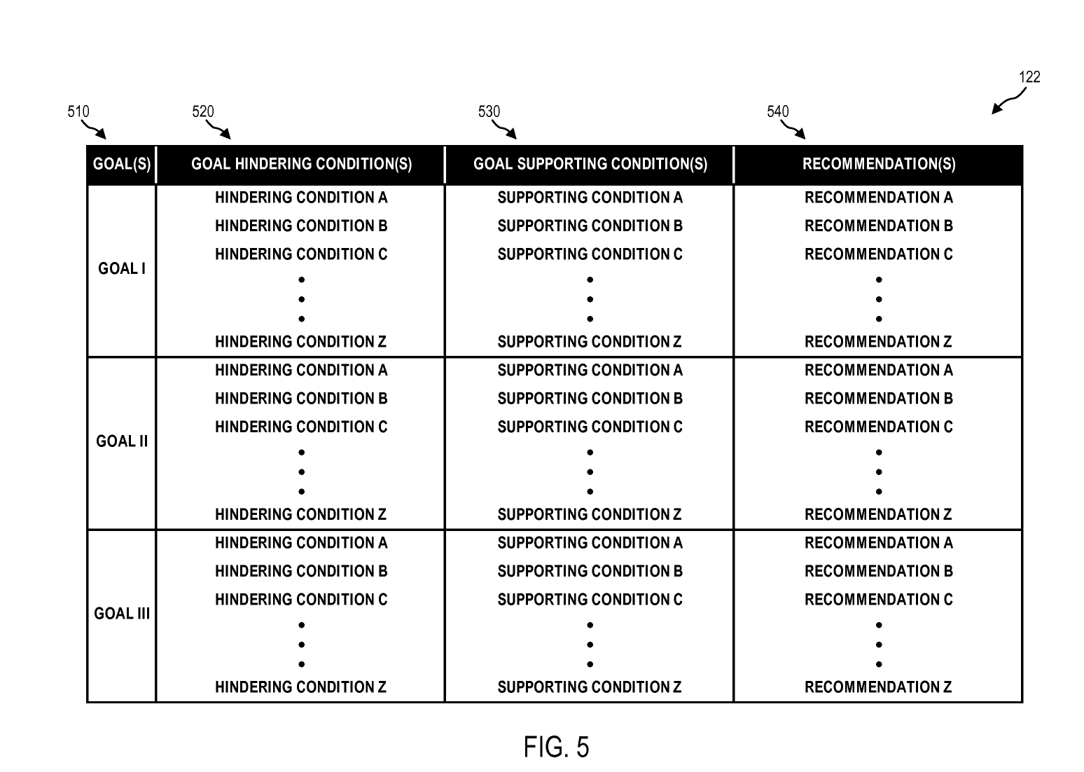

In use, the goal achievement server 110 monitors online content (e.g., web content, social media content, etc.) related to the online presence of a user (e.g., an individual user, a group of users, an entity, etc.). In some embodiments, the online presence of a user may include the user's online identity and/or reputation established via the user's online activity (e.g., social networking posts, social networking status updates, social networking profile pictures, social networking friends or contacts, blog posts, microblog posts, website posts, online product reviews, personal photo uploads, online rants, online groups, news feed subscriptions, online content approvals or “likes,” online content disapprovals or “dislikes,” online product rankings, online content rankings, online communications, etc.). Additionally or alternatively, the online presence of a user may be established via another user's online activity that impacts the user's online identity and/or reputation (e.g., negative product reviews, socially unacceptable social networking posts, embarrassing photo uploads, etc.). Regardless of how the user's online presence is established, the goal achievement server 110 determines recommendations regarding the online content based on one or more goals (e.g., the goal(s) 510 of FIG. 5) of the user. Each goal to be achieved by the user may be embodied as any type of goal indicative of a specific personal and/or professional objective relating to the user's online presence (e.g., the user's online identity and/or reputation). To determine the recommendations, the goal achievement server 110 is configured to receive a selection of a goal from the user. The goal achievement server 110 indexes online content that is provided by the online service provider(s) 130 and that relates to the selected goal. The goal achievement server 110 compares the indexed online content against a goal database 122, which includes one or more hindering conditions (e.g., the goal hindering condition(s) 520 of FIG. 5) that hinder (e.g., impede, obstruct, interfere with, etc.) achievement of the selected goal and/or one or more supporting conditions (e.g., the goal supporting condition(s) 530) that support (e.g., facilitate, aid, promote, help, etc.) achievement of the selected goal. As a function of determining that the indexed online content satisfies a hindering condition and/or a supporting condition of the selected goal, the goal achievement server 110 determines one or more recommendations for achieving the selected goal.

In some embodiments, the goal achievement server 110 is also configured to receive content that is to be posted online by the user's computing device 140 and generate a recommendation regarding the content based on a goal selected by the user. To do so, the goal achievement server 110 compares the received content against the goal database 122 to determine whether the received content satisfies one or more hindering conditions and/or supporting conditions of the selected goal. Based on a determination that the received content satisfies a hindering condition and/or a supporting condition, the goal achievement server 110 determines one or more recommendations for achieving the selected goal.

The goal achievement server 110 may be embodied as, or otherwise include, any type of computing device capable of performing the functions described herein including, but not limited to a server computer, a desktop computer, a laptop computing device, a home automation gateway device, a programmable logic controller, a smart television, a smart appliance, a consumer electronic device, a wireless access point, a network switch, a network router, a mobile computing device, a mobile phone, a smart phone, a tablet computing device, a personal digital assistant, a wearable computing device, and/or other type of computing device. The illustrative goal achievement server 110 includes a processor 112, a memory 114, an input/output (I/O) subsystem 116, communication circuitry 118, and a data storage 120. Of course, the goal achievement server 110 may include other or additional components, such as those commonly found in a computer (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 112 in some embodiments.

The processor 112 may be embodied as any type of processor capable of performing the functions described herein. For example, the processor 112 may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the goal achievement server 110 such as operating systems, applications, programs, libraries, and drivers. The memory 114 is communicatively coupled to the processor 112 via the I/O subsystem 116, which may be embodied as circuitry and/or components to facilitate input/output operations with the processor 112, the memory 114, and other components of the goal achievement server 110. For example, the I/O subsystem 116 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 116 may form a portion of a system-on-a-chip (SoC) and be incorporated, along with the processor 112, the memory 114, and other components of the goal achievement server 110, on a single integrated circuit chip.

The communication circuitry 118 of the goal achievement server 110 may be embodied as any type of communication circuit, device, or collection thereof, capable of enabling communications between the goal achievement server 110 and the online service provider(s) 130, the computing device 140, and/or other computing devices. The communication circuitry 118 may be configured to use any one or more communication technologies (e.g., wireless or wired communications) and associated protocols (e.g., Ethernet, Wi-Fi®, WiMAX, etc.) to effect such communication.

The data storage 120 may be embodied as any type of device or devices configured for short-term or long-term storage of data such as, for example, memory devices and circuits, memory cards, hard disk drives, solid-state drives, or other data storage devices. In some embodiments, the data storage 120 may be configured to store the goal database 122. As illustratively shown in FIG. 5, the goal database 122 may include one or more goals 510 available for selection by the user. As discussed above, each goal 510 may be indicative of a specific personal and/or professional objective relating to the user's online presence (e.g., the user's online identity and/or reputation). As such, each goal 510 may affect one or more aspects of the user's online presence. For example, in some embodiments, a goal 510 may be to increase a level of the user's online visibility and/or online reputation. Another goal 510 may be to prevent confidential information from being disclosed online. It should be appreciated that although the goals 510 in the goal database 122 are related to, or otherwise affect, the user's online identity and/or reputation (e.g., the user's online presence) in the illustrative embodiment, such goals may also affect the user's offline identity and/or reputation (e.g., one or more aspects of the user's personal and/or professional life). For example, in some embodiments, a goal 510 may be to prevent the user from posting unprofessional content online, which if discovered by a prospective employer, may lessen the user's chances of being hired.

To facilitate the user achieving a particular goal 510, the goal database 122 may also include one or more hindering conditions 520 that hinder (e.g., impede, obstruct, interfere with, etc.) achievement of each goal 510 available for selection by the user and/or one or more supporting conditions 530 that support (e.g., facilitate, aid, promote, help, etc.) achievement of each goal 510 available for selection by the user. As discussed in more detail below, the hindering condition(s) 520 and supporting condition(s) 530 related to a particular goal 510 may be indicative of online content and/or user-generated content (e.g., textual content, visual content, aural content, etc.) that hinders and/or supports achievement of that goal 510. In some embodiments the hindering condition(s) 520 and supporting condition(s) 530 may be embodied as one or more keywords or phrases (e.g., socially acceptable words or phrases, offensive words or phrases, the user's legal name, a company name, a product name, words indicative of a negative product review, words related to confidential information, etc.) that may be compared against the online content and/or user-generated content to facilitate determining whether all or a portion of the online content and/or user-generated content supports and/or hiders achievement of a particular goal 510.

In some embodiments, each goal 510 in the goal database 122 may also include one or more recommendations 540 for achieving that goal 510. The recommendation(s) 540 may be indicative of one or more online actions that the user should take and/or not take (e.g., post specific types of content online, not post specific types of content online, revise new content to be posted online, remove existing online content, revise existing online content, etc.) to facilitate achievement of a particular goal 510. In some embodiments, the recommendation(s) 540 for a particular goal 510 may be generated based on the hindering condition(s) 520 and/or the supporting condition(s) 530 for that goal 510. Additionally or alternatively, the recommendation(s) 540 for a particular goal 510 may be unrelated to the hindering condition(s) 520 and/or the supporting condition(s) 530 of that goal 510. For example, the recommendation(s) 540 for a particular goal 510 may include a recommendation for posting a reference quantity of posts on a company blog to facilitate increasing the company's visibility. In another example, the recommendation(s) 540 for a particular goal 510 may include a recommendation for making a reference quantity of new online contacts within a set period of time. It should be appreciated that the recommendation(s) 540 may be embodied as any type of recommendation that facilitates achievement of a goal 510 that affects the online and/or offline reputation and/or visibility of an individual user, an entity (e.g., a company, a social group, etc.), and/or an object or location (e.g., a product, a location, etc.).

Referring back to FIG. 1, as discussed, the goal achievement server 110 may communicate with the online service provider(s) 130 and/or the computing device 140 over the network 150. The network 150 may be embodied as any number of various wired and/or wireless communication networks. For example, the network 150 may be embodied as or otherwise include a local area network (LAN), a personal area network (PAN), a wide area network (WAN), a cellular network, or a publicly-accessible, global network such as the Internet. Additionally, the network 150 may include any number of additional devices to facilitate communication between the goal achievement server 110, the online service provider(s) 130, the computing device 140, and other devices of the system 100 as discussed below.

The one or more online service providers 130 may be embodied as any type of online service provider that provides electronic services (e.g., social networking, website content, online chatting, e-mail services, online transactions, online purchases, electronic billing statements, electronic bill payment, account balances, etc.) over the network 150 to the user. As such, the online service provider(s) 130 may include devices and structures commonly found in online service providers, which are not shown in FIG. 1 for clarity of the description. In some embodiments, the one or more online service provider(s) 130 may be configured to communicate with the goal achievement server 110 and/or the computing device 140 over the network 150. Additionally, as discussed in more detail below, the online service provider(s) 130 may be configured to provide, over the network 150, online content (e.g., communication messages and/or electronic data) corresponding to the user to the goal achievement server 110.

The computing device 140 may be embodied as any type of computing device or processing device capable of communicating with the goal achievement server 110 and performing the functions described herein including, but not limited to, a desktop computer, a laptop computing device, a mobile computing device, a mobile phone, a smart phone, a tablet computing device, a personal digital assistant, a server computer, a smart television, a consumer electronic device, and/or other type of computing device. As such, the computing device 140 may include devices and structures commonly found in computing devices such as processors, memory devices, communication circuitry, and data storages, which are not shown in FIG. 1 for clarity of the description. As discussed in more detail below, the computing device 140 may transmit content to be posted online to the goal achievement server 110 and receive a recommendation back regarding the posting of that content. Additionally, in some embodiments, the recommendation received from the goal achievement server 110 may indicate that the content should not be posted online. In such embodiments, the computing device 140 may block (e.g., prevent, stop, etc.) the content from being posted online in response.

It should be appreciated that in some embodiments, the goal achievement server 110 (e.g., the goal achievement computing device) may also include any of the components and/or functionality of the computing device 140 discussed herein. Likewise, the computing device 140 may also include any of the components and/or functionality of the goal achievement server 110 (e.g., the goal achievement computing device) discussed herein. For example, in addition to analyzing content to be posted online and generating goal-based recommendations therefrom, the computing device 140 may also be configured to monitor existing online content related to the online presence of the user and generate corresponding goal-based recommendations.

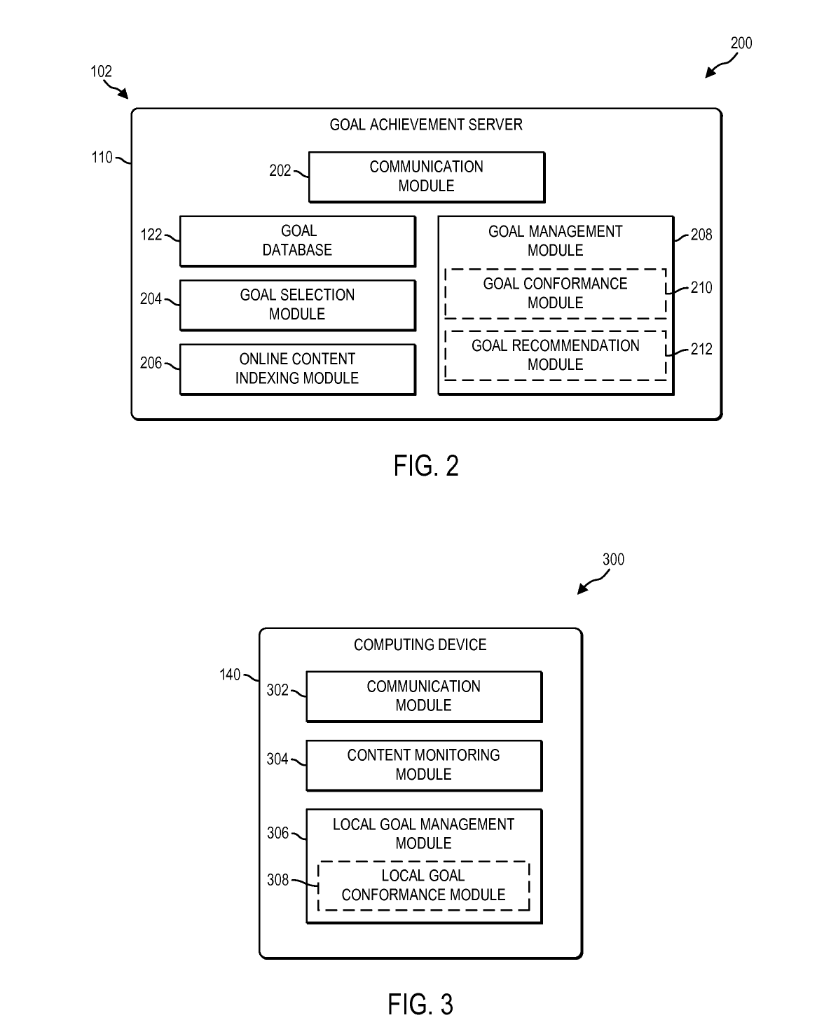

Referring now to FIG. 2, in use, the goal achievement server 110 establishes an environment 200 during operation. The illustrative environment 200 includes a communication module 202, a goal selection module 204, an online content indexing module 206, a goal management module 208, and the goal database 122. As discussed in more detail below, the goal management module 208 may include a goal conformance module 210 and a goal recommendation module 212 in some embodiments. Each of the modules 202, 204, 206, 208, 210, 212, and 122 of the environment 200 may be embodied as hardware, software, firmware, or a combination thereof. It should be appreciated that the goal achievement server 110 may include other components, sub-components, modules, and devices commonly found in a computing device, which are not illustrated in FIG. 2 for clarity of the description.

The communication module 202 of the goal achievement server 110 facilitates communications between components or sub-components of the goal achievement server 110 and the online service provider(s) 130 and/or the computing device 140. For example, in some embodiments, the communication module 202 may facilitate receiving online content from the online service provider(s) 130. The communication module 202 may also facilitate receiving content that is to be posted online from the computing device 140. In some embodiments, the communication module 202 facilitates sending (e.g., transmitting) one or more recommendations to the computing device 140.

As discussed, the goal database 122 may include one or more goals 510 available for selection by the user. Each goal 510 may be related to the online presence of the user (e.g., the user's online identity and/or reputation). As such, each goal 510 may be indicative of a level of online visibility and/or online reputation that the user desires to achieve. To facilitate the user achieving a particular goal 510, the goal database 122 may also include one or more hindering condition(s) 520, supporting condition(s) 530, and/or recommendation(s) 540 for each goal 510 in the goal database 122.

The goal selection module 204 is configured to present one or more the goals 510 to the user for selection. In use, the goal selection module 204 may retrieve the goal(s) 510 available for selection from the goal database 122. In some embodiments, the goal selection module 204 may transmit the goal(s) 510 to the computing device 140, which may be configured to display or otherwise present (e.g., via an associated display device) the goal(s) 510 to the user for selection therefrom. In other embodiments, the goal selection module 204 may also be configured to present the goal(s) 510 to the user via a display device of the goal achievement server 110. It should be appreciated that the goal selection module 204 may present the goal(s) 510 available for selection to the user on any device (e.g., the goal achievement server 110, the computing device 140, and/or any other computing or display device) in any suitable format (e.g., a list, a table, a widget, a graphically, textually, audibly, etc.).

The goal selection module 204 is configured to receive the user's selection of a particular goal 510. For example, in some embodiments, the goal selection module 204 may receive a communication message from the computing device 140 indicative of the user's selection of a particular goal 510 via an input of the computing device 140. Additionally or alternatively, the goal selection module 204 may receive a signal and/or message from one or more components (e.g., one or more inputs, user interfaces, etc.) of the goal achievement server 110 indicative of the user's selection of a particular goal 510.

The online content indexing module 206 is configured to index online content related to a selected goal 510 and/or the user. For example, in some embodiments, the online content indexing module 206 may retrieve (e.g. download or otherwise obtain) social media content (e.g., social networking posts, social networking comments, social networking chat messages, social networking status updates, etc.) related to the selected goal 510 and/or the user from the online service provider(s) 130. Additionally or alternatively, the online content indexing module 206 may retrieve web content (e.g., textual content, visual content, or aural content associated with one or more web pages) related to the selected goal 510 and/or the user from the online service provider(s) 130. It should be appreciated that the online content indexing module 206 may retrieve or download all or a portion of the online content (e.g., social media content and/or web content) related to the selected goal 510 and/or the user. For example, in some embodiments, the online content indexing module 206 may be configured to access the online service provider(s) 130 using credentials provided by the user (e.g., a username, a password, a passphrase, etc.) and download or otherwise retrieve only the online content that relates to the selected goal 510 and/or the user. Additionally or alternatively, the online content indexing module 206 may download or otherwise retrieve only the online content that matches or is substantially similar to (or is otherwise related to) one or more keywords provided by the user. For example, the online content indexing module 206 may be configured to retrieve only the online content that matches the legal name of the user. The online content indexing module 206 may also be embodied as a web crawler configured to crawl and index the online content provided (e.g., social media content and/or web content) by the online service provider(s) 130 in some embodiments.

The goal management module 208 is configured to analyze the indexed online content and/or content received from the computing device 140 (e.g., electronic content that is to be posted online) To do so, the goal management module 208 may include the goal conformance module 210. The goal conformance module 210 is configured to determine whether the indexed online content and/or the received content to be posted online conforms to the selected goal 510.

To do so, the goal conformance module 210 may compare the indexed online content and/or the received content to the goal database 122 to determine whether any portion of the indexed online content and/or received content satisfies the hindering condition(s) 520 and/or the supporting condition(s) 530 associated with the selected goal 510. In doing so, the goal conformance module 210 determines whether the indexed online content and/or the received content, or portions thereof, either support or hinder achievement of the selected goal 510.

The goal management module 208 is also configured to determine one or more recommendations and/or suggestions for achieving the selected goal 510 based on the goal database 122. To do so, in some embodiments, the goal management module 208 may include the goal recommendation module 212. The goal recommendation module 212 is configured to generate recommendations 540 related to the indexed online content and/or received content based on, or otherwise as function of, the hindering condition(s) 520 and/or the supporting condition(s) 530 for the selected goal 510. For example, in some embodiments, the goal recommendation module 212 may generate a recommendation 540 that a portion of the indexed online content and/or the content to be posted online should be removed and/or revised. In another example, the goal recommendation module 212 may generate a recommendation 540 to post content online that facilitates achievement of the selected goal 510. It should be appreciated that the goal recommendation module 212 may generate any number of different recommendations 540 related to the indexed online content and/or the received content (e.g., content that is to be posted online).

Additionally or alternatively, the goal recommendation module 212 may be configured to retrieve one or more predefined and/or user-generated recommendations 540 associated with the selected goal 510 from the goal database 122. In some embodiments, the predefined recommendations (e.g., reference recommendations) and/or user-generated recommendations 540 may be unrelated to the hindering condition(s) 520 and/or supporting condition(s) 530 associated with selected goal 510. That is, the predefined and/or user-generated recommendations 540 may be embodied as additional recommendations and/or suggestions separate from those generated based on the hindering condition(s) 520 and/or supporting condition(s) 530. For example, in some embodiments, the predefined and/or user-generated recommendations 540 received from the goal database 122 may be embodied as one or more additional online actions (e.g., post online content of a particular type, post online content relating to a particular subject, post online content relating to a particular website, increase a website's ranking in search results, increase the number of social media contacts the user has, advertise on particular websites, respond to online posts within a reference period of time, post positive consumer reviews online, publish a mobile application, monitor a website's usage statistics, revise a website's content based on usage statistics, target new markets and/or audiences, etc.) the user may take to facilitate achievement of the selected goal 510.

Referring now to FIG. 3, in use, the computing device 140 establishes an environment 300 during operation. The illustrative environment 300 includes a communication module 302, a content monitoring module 304, and a local goal management module 306. As discussed in more detail below, the local goal management module 306 may include a local goal conformance module 308 in some embodiments. Each of the modules 302, 304, 306, and 308 of the environment 300 may be embodied as hardware, software, firmware, or a combination thereof It should be appreciated that computing device 140 may include other components, sub-components, modules, and devices commonly found in a computing device, which are not illustrated in FIG. 3 for clarity of the description.

The communication module 302 of the computing device 140 facilitates communications between components or sub-components of the computing device 140 and the goal achievement server 110 and/or online service provider(s) 130. For example, in some embodiments, the communication module 302 may facilitate receiving one or more recommendations from the goal achievement server 110. In some embodiments, the communication module 302 also facilitates transmitting content that is to be posted online to the goal achievement server 110 and/or the online service provider(s) 130.

The content monitoring module 304 is configured to monitor for electronic content (e.g., social networking posts, social networking comments, social networking chat messages, images, audio clips, files, etc.) that is to be posted online by the user. To do so, the content monitoring module 304 may monitor the user's outgoing communication messages and determine whether any include content that is to be posted online (e.g., transmitted to the online service provider(s) 130). In some embodiments, the content monitoring module 304 may monitor only those outgoing communication messages that are destined for the online service provider(s) 130. In other embodiments, the content monitoring module 304 may monitor all communications messages (e.g., incoming and outgoing messages) for content that is to be posted online regardless of the specific source and/or destination of the communication messages. In response to determining that a communication message includes content that is to be posted online, the content monitoring module 304 may be configured to flag the communication for further processing. Additionally or alternatively, the content monitoring module may notify (e.g., via a notification message, control signal, output, etc.) one or more other components of the computing device 140 (e.g., the local goal management module 306) of the communication.

The local goal management module 306 is configured to determine whether the identified content should be posted online based on a selected goal 510. To do so, in some embodiments, the local goal management module 306 includes the local goal conformance module 308. The local goal conformance module 308 is configured to transmit the content that is to be posted online to the goal achievement server 110 for further processing or analysis (e.g., determining whether all or a portion of the content satisfies the one or more hindering condition(s) 520 and/or supporting condition(s) 530 of a selected goal 510). In some embodiments, the local goal conformance module 308 only transmits the identified content to the goal achievement server 110 for further processing and/or analysis. However, in other embodiments, the local goal conformance module 308 may transmit the entire communication message including the identified content to the goal achievement server 110.

The local goal conformance module 308 may also receive one or more recommendations 540 related to the content from the goal achievement server 110. In addition to being related to the content, the recommendations 540 received from the goal achievement server 110 may be based on the goal 510 selected by the user. For example, in some embodiments, the local goal conformance module 308 may receive a recommendation 540 to post the content online as is, revise a portion of the content prior to being posted online, and/or remove a portion of the content prior to being posted online to facilitate achieving the selected goal 510. Additionally or alternatively, the local goal conformance module 308 may receive a recommendation 540 indicating that the content should be blocked (e.g., prevented, stopped, etc.) from being posted online altogether.

The local goal conformance module 308 is also configured to block (e.g., prevent, stop, etc.) the content from being posted online. To do so, the local goal conformance module 308 may prevent (e.g., drop, discard, delete, etc.) the content from being transmitted to the online service provider(s) 130 and/or other computing devices via the network 150 in response to receiving an associated recommendation 540 and/or instruction from the goal achievement server 110. Additionally or alternatively, the local goal conformance module 308 is configured to present the recommendations 540 received from goal achievement server 110 that relate to the content that is to be posted online.

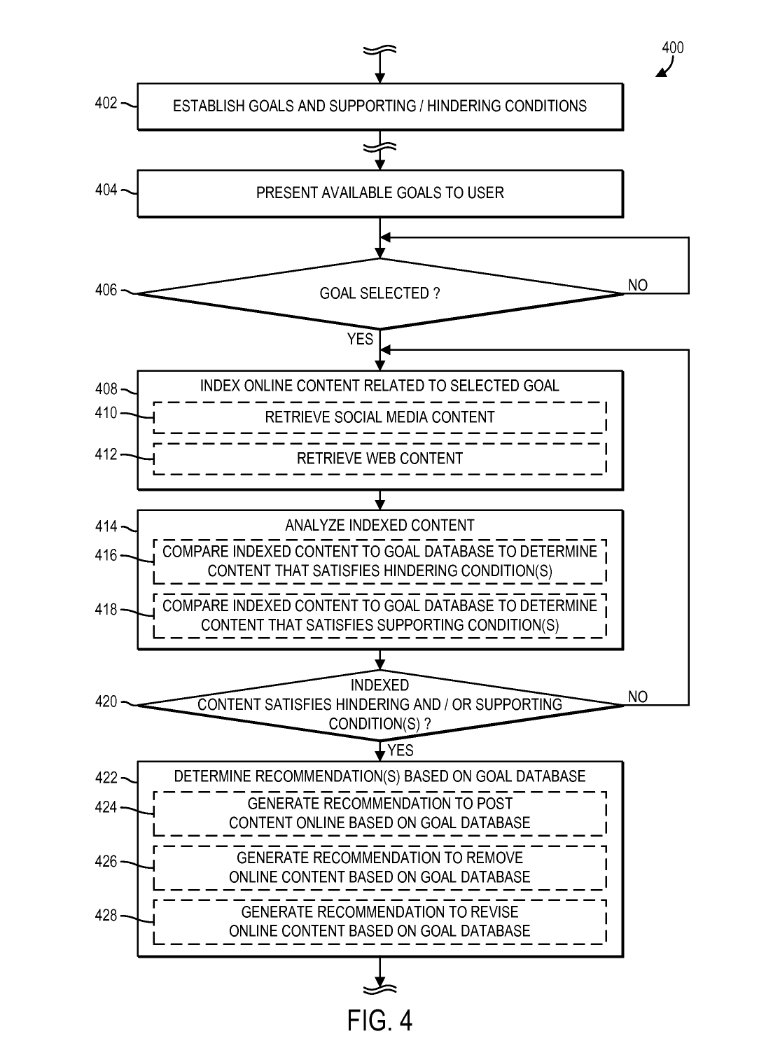

Referring now to FIG. 4, the goal achievement server 110 may execute a method 400 for managing the achievement of one or more goals 510 of the user. The method 400 begins with block 402 in which one or more goals 510 are established for selection by the user. In some embodiments, the established goals 510 may include one or more predefined or reference goals created by an administrator or supplier of the goal achievement server 110. Additionally or alternatively, the established goals 510 may include one or more user-created goals. The established goals 510 may be stored in the goal database 122 and made available for selection by the user.

As discussed, in some embodiments, each goal 510 in the goal database 122 may include one or more hindering condition(s) 520 and/or one or more supporting condition(s) 530 associated therewith. In such embodiments, in block 402, the hindering condition(s) 520 and/or supporting condition(s) 530 may also be established for each goal 510. The hindering conditions(s) 520 and/or supporting condition(s) 530 established for each goal 510 may be embodied as one or more hindering condition(s) 520 and/or supporting condition(s) 530 created by an administrator or supplier of the goal achievement server 110 and/or one or more hindering condition(s) 520 and/or supporting condition(s) 530 created by the user.

In block 404, one or more goals 510 available for selection are presented to the user. To do so, goal achievement server 110 may retrieve the goal(s) 510 available for selection from the goal database 122. In some embodiments, the goal(s) 510 may be transmitted to the computing device 140, which may be configured to display or otherwise present (e.g., via an associated display device) the goal(s) 510 to the user for selection therefrom. It should be appreciated that the goal achievement server 110 may present the goal(s) 510 available for selection to the user on any device (e.g., the goal achievement server 110, the computing device 140, and/or any other computing or display device) in any suitable format (e.g., a list, a table, a widget, a graphically, textually, audibly, etc.).

In block 406, the goal achievement server 110 determines whether a goal 510 has been selected by the user. To do so, in some embodiments, the goal achievement server 110 may determine whether a communication message including a selected goal 510 is received from the computing device 140. Additionally or alternatively, the goal achievement server 110 may determine whether a message and/or signal indicative of the user selecting a goal 510 is generated by one or more components of the goal achievement server 110. For example, the goal achievement server 110 may determine whether the user has selected a goal 510 via one or more inputs (e.g., keyboard, touchscreens, pointer devices, etc.) of the goal achievement server 110. If, in block 406, the goal achievement server 110 determines that a goal 510 has been selected by the user, the method 400 advances to block 408. If, however, the goal achievement server 110 determines instead that a goal 510 has not been selected by the user, the method 400 loops back to block 406 in which the goal achievement server 110 continues determining whether a goal 510 is selected.

In block 408, the goal achievement server 110 indexes online content (e.g., social media content and/or web content) related to the selected goal 510 and/or the user. To do so, in some embodiments, the goal achievement server 110 retrieves (e.g. downloads), or otherwise obtains, social media content (e.g., social networking posts, social networking comments, social networking chat messages, social networking status updates, etc.) related to the selected goal 510 and/or the user from the online service provider(s) 130 in block 410. Additionally or alternatively, in block 412, the goal achievement server 110 retrieves web content (e.g., textual content, visual content, or aural content associated with one or more web pages) related to the selected goal 510 and/or the user from the online service provider(s) 130. In some embodiments, the goal achievement server 110 retrieves or downloads all or a portion of the online content (e.g., social media content and/or web content) related to the selected goal 510 and/or the user.

In block 414, the goal achievement server 110 analyzes the indexed online content based on the goal database 122. For example, in block 416, the goal achievement server 110 compares the indexed online content to the goal database 122 to determine whether any portion of the indexed online content satisfies the hindering condition(s) 520 associated with the selected goal 510. In doing so, the goal achievement server 110 determines whether the indexed online content, or a portion thereof, hinders achievement of the selected goal 510. Additionally or alternatively, in block 418, the goal achievement server 110 compares the indexed online content to the goal database 122 to determine whether any portion of the indexed online content satisfies the supporting condition(s) 530 associated with the selected goal 510. In doing so, the goal achievement server 110 determines whether the indexed online content, or a portion thereof, supports achievement of the selected goal 510. The method 400 advances to decision block 420. If, in decision block 420, the goal achievement server 110 determines that the indexed online content (or a portion thereof) satisfies the hindering condition(s) 520 and/or the supporting condition(s) 530 of the selected goal 510, the method 400 advances to block 422. If, however, the goal achievement server 110 instead determines that the indexed online content (or a portion thereof) does not satisfy the hindering condition(s) 520 and/or the supporting condition(s) 530 of the selected goal 510, the method 400 loops back to block 408 in which the goal achievement server 110 continues indexing the online content related to the selected goal 510 and/or the user.

In block 422, the goal achievement server 110 determines one or more recommendations related to the indexed online content based on the goal database 122. For example, in block 424, the goal achievement server 110 may generate one or more recommendations to post new content online that supports achievement of the selected goal 510. In block 426, the goal achievement server 110 may also generate one or more recommendations to remove (e.g., takedown, delete, erase, etc.) a portion of the indexed online content that hinders achievement of the selected goal 510. In some embodiments, in block 428, the goal achievement server 110 may also generate one or more recommendations to revise (e.g., edit, redact, append, replace, etc.) a portion of the indexed online content that hinders achievement of the selected goal 510.

In some embodiments, the goal achievement server 110 generates the recommendation(s) based on, or otherwise as function of, the hindering condition(s) 520 and/or the supporting condition(s) 530 for the selected goal 510. For example, based on the hindering condition(s) 520 associated with the selected goal 510, the goal achievement server 110 may determine that the user previously posted offensive words or phrases to a social networking website. As a function of that determination, the goal achievement server 110 may generate a recommendation that the user revise or remove the offensive words or phrases from the social networking website to facilitate achievement of the selected goal 510. In another example, based on the hindering condition(s) 520 associated with the selected goal 510, the goal achievement server 110 may also determine that a third party user (e.g., a different user) posted content online that defames the user or otherwise has a negative impact on the user's online and/or off-line identity or reputation. In response to making such a determination, the goal achievement server 110 may generate a recommendation that the user remove (or have removed/taken down) the defamatory and/or negative online content. In yet another example, based on the supporting condition(s) 530 associated with the selected goal 510, the goal achievement server 110 may determine that the user (e.g., a company or organizational entity) posted positive marketing content (e.g., positive customer reviews, professional recommendations, etc.) to a website. In doing so, the goal achievement server 110 may generate a recommendation that the user continue to post similar marketing content to the website to facilitate achieving the selected goal 510.

Additionally or alternatively, the goal achievement server 110 retrieves one or more predefined and/or user-generated recommendations 540 associated with the selected goal 510 from the goal database 122. In some embodiments, the predefined recommendations (e.g., reference recommendations) and/or user-generated recommendations 540 may be unrelated to the hindering condition(s) 520 and/or supporting condition(s) 530 associated with selected goal 510. That is, the predefined and/or user-generated recommendations 540 may be embodied as additional recommendations separate from those generated based on the hindering condition(s) 520 and/or supporting condition(s) 530. For example, the predefined and/or user-generated recommendations 540 for the selected goal 510 may include a recommendation for posting a reference quantity of posts on a company blog to facilitate increasing the company's visibility. In another example, the predefined and/or user-generated recommendations 540 for the selected goal 510 may include a recommendation that a company update their website to include metadata and/or links to increase the website's ranking within search results.

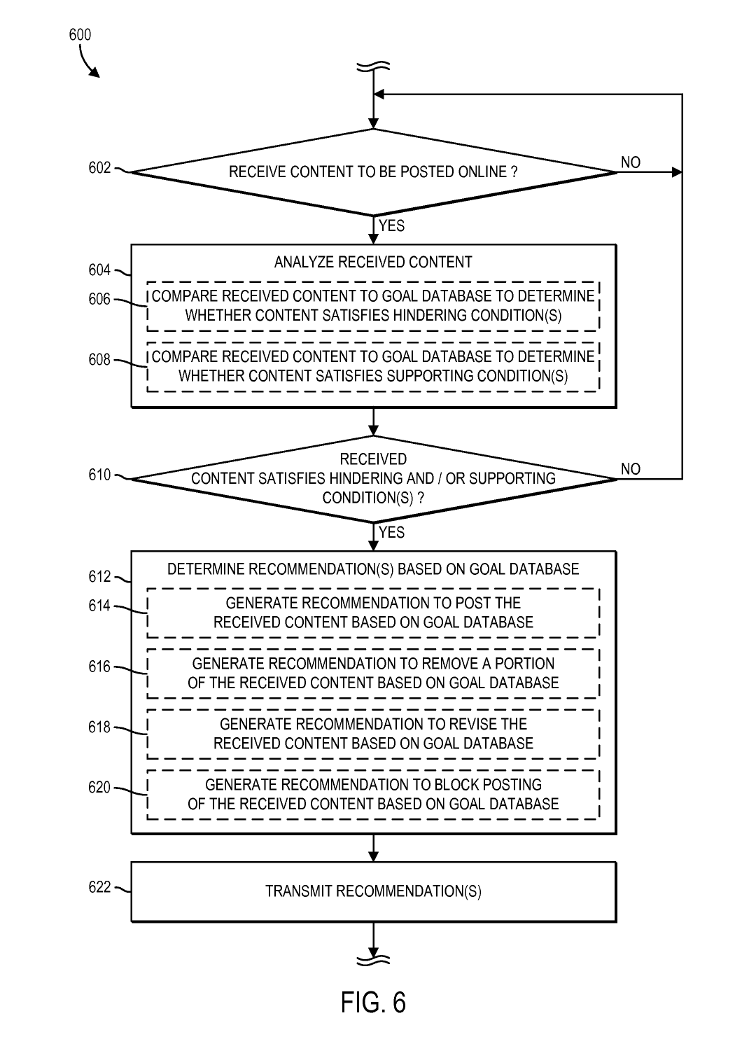

Referring now to FIG. 6, the goal achievement server 110 may execute a method 600 for generating recommendations related to content that is to be posted online by the computing device 140. In some embodiments, the method 600 may be executed contemporaneously to, or as subroutine of, the method 400 of FIG. 4. The method 600 begins with block 602 in which the goal achievement server 110 determines whether content to be posted online is received. To do so, the goal achievement server 110 may determine whether a communication message including content to be posted online is received from the computing device 140 via the network 150. In some embodiments, the goal achievement server 110 may receive only the content that is to be posted online rather than the entire communication message. If, in block 602, the goal achievement server 110 determines that content to be posted online is received, the method 600 advances to block 604. If, however, the goal achievement server 110 determines that content to be posted online is not received, the method 600 loops back to block 602 in which the goal achievement server 110 continues determining whether content to be posted online is received.

In block 604, the goal achievement server 110 analyzes the received content to be posted online based on the goal database 122. For example, in block 606, the goal achievement server 110 compares received content to the goal database 122 to determine whether any portion of the received content satisfies the hindering condition(s) 520 associated with a goal 510 selected by the user. In doing so, the goal achievement server 110 determines whether the received content (or a portion thereof) hinders achievement of the selected goal 510. Additionally or alternatively, in block 608, the goal achievement server 110 compares the received content to the goal database 122 to determine whether any portion of the received content satisfies the supporting condition(s) 530 associated with the selected goal 510. In doing so, the goal achievement server 110 determines whether the received content (or a portion thereof) supports achievement of the selected goal 510. The method 600 advances to decision block 610. If, in decision block 610, the goal achievement server 110 determines that the received content, or a portion thereof, satisfies the hindering condition(s) 520 and/or the supporting condition(s) 530 of the selected goal 510, the method 600 advances to block 612. If, however, the goal achievement server 110 instead determines that the received content, or a portion thereof, does not satisfy the hindering condition(s) 520 and/or the supporting condition(s) 530 of the selected goal 510, the method 600 loops back to block 620 in which the goal achievement server 110 continues determining whether content to be posted online is received from the computing device 140.

In block 612, the goal achievement server 110 determines one or more recommendations related to the received content based on the goal database 122. In some embodiments, the goal achievement server 110 generates the recommendation(s) related to the received content based on, or otherwise as function of, the hindering condition(s) 520 and/or the supporting condition(s) 530 for the selected goal 510. For example, in block 614, the goal achievement server 110 may generate a recommendation that the received content should be posted online based on determining that the received content satisfies the supporting condition(s) 530 and not the hindering condition(s) 520 associated with the selected goal 510. In another example, in block 616, the goal achievement server 110 may generate a recommendation that prior to posting the received content online, a portion of the received content should be removed. Such recommendation may be generated based on the goal achievement server 110 determining that a portion of the received content satisfies the hindering condition(s) 520 associated with the selected goal 510. Similarly, in block 618, the goal achievement server 110 may also generate a recommendation that a portion of the received content should be removed prior to being posted online in response to determining that the received content satisfies the hindering condition(s) 520. Additionally or alternatively, in block 620, the goal achievement server 110 may also generate a recommendation that the received content should be blocked (e.g., prevented, stopped, etc.) from being posted online in response to determining that the received content satisfies the hindering condition(s) 520 of the selected goal 510. That is, the goal achievement server 110 may also generate a recommendation that the computing device 140 should block the content from being transmitted to the online service provider(s) 130. It should be appreciated that although the achievement server 110 generates one or more recommendations regarding the received content to be posted online in the illustrative embodiment, the goal achievement server 110 may instead generate one or more instructions related to the received content (e.g., an instruction to block posting of the content online, an instruction to revise the content prior to being posted online, an instruction to remove a portion of the content prior to being posted online, an instruction to post the content online, etc.).

After determining the recommendation(s) in block 612, the method 600 advances to block 622. In block 622, the goal achievement server 110 transmits the recommendation(s) related to the received content to the computing device 140. In embodiments wherein instructions related to the received content are generated, the goal achievement server 110 transmits the generated instructions to the computing device 140.

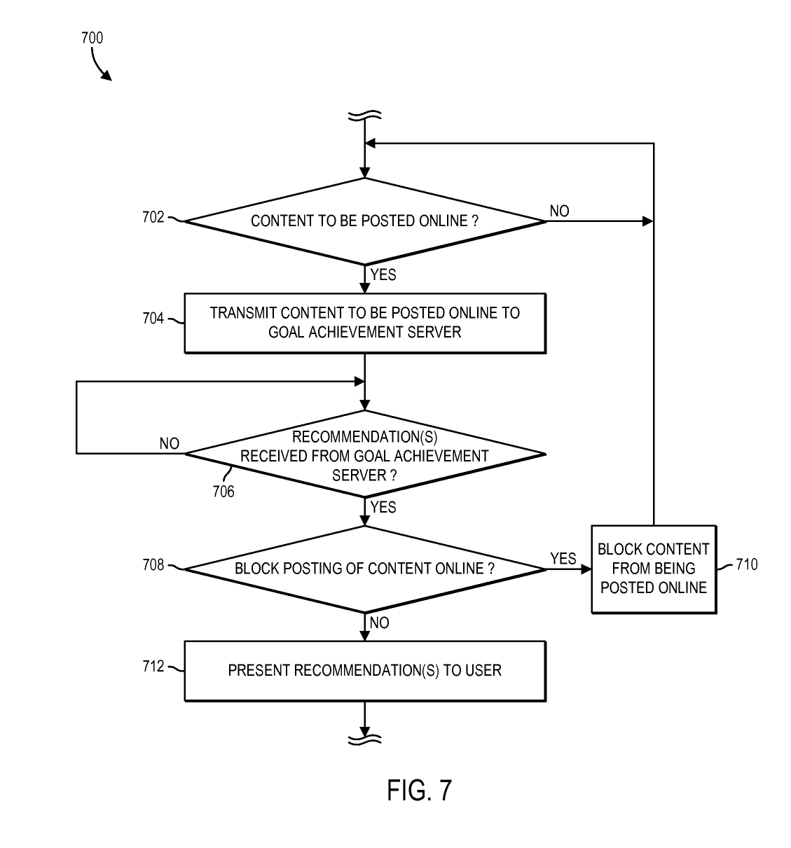

Referring now to FIG. 7, the computing device 140 may execute a method 700 for receiving recommendations and/or instructions from the goal achievement server 110 that relate to content that is to be posted online. The method 700 begins with block 702 in which the computing device 140 determines if the user is attempting to post electronic content (e.g., social networking posts, social networking comments, social networking chat messages, images, audio clips, files, etc.) online. To do so, the computing device 140 may monitor communication messages generated on the computing device 140 by the user to determine whether any includes content that is to be posted online (e.g., transmitted to the online service provider(s) 130). In some embodiments, the computing device 140 monitors all communication messages generated by the user to identify content that is to be posted online. Additionally or alternatively, the computing device 140 monitors only those messages that are destined to a specific destination (e.g., the online service provider(s) 130) to identify content that is to be posted online. In either case, the computing device 140 may determine the user is attempting to post content online in response to identifying content generated by the user included within a communication message. If, in block 702, the computing device 140 determines that the user is not attempting to post content online, the method 700 returns to block 702 in which the computing device 140 continues monitoring communication messages generated by the user. If, however, the computing device 140 determines instead that the user is attempting to post content online, the method 700 advances to block 704. In block 704, the computing device 140 transmits the communication including the content to the goal achievement server 110 for further processing and/or analysis (e.g., determining whether all or a portion of the content satisfies one or more hindering condition(s) 520 and/or supporting condition(s) 530 of a selected goal 510).

In block 706, the computing device 140 determines whether a recommendation regarding the content to be posted online is received from the goal achievement server 110. In some embodiments, the recommendation may include a recommendation configured to be presented to the user to facilitate achievement of the selected goal 510. For example, the recommendation may indicate that the user should post the content online as is, remove a portion of the content prior to posting, and/or revise a portion of the content prior to posting. Additionally or alternatively, the recommendation received from the goal achievement server 110 may be indicative of a recommendation to block (e.g., prevent, stop, etc.) the content from being posted online. It should be appreciated that although the computing device 140 receives a recommendation from the goal achievement server 110 regarding the content to be posted online in the illustrative embodiment, the computing device 140 may instead receive an instruction (e.g., an instruction to block posting of the content online, an instruction to revise the content prior to being posted online, an instruction to remove a portion of the content prior to being posted online, an instruction to post the content online, etc.) from the goal achievement server 110 in other embodiments. If, in block 706, the computing device 140 determines that a recommendation regarding the content to be posted online is received from the goal achievement server 110, the method 700 advances to block 708. If, however, the computing device 140 determines instead that a recommendation regarding the content to be posted online is not received from the goal achievement server 110, the method 700 loops back to block 706 in which the computing device 140 continues determining whether a recommendation is received.

In block 708, the computing device 140 determines whether the received recommendation is indicative of a recommendation to block (e.g., prevent, stop, etc.) the content from being posted online. If, in block 708, the computing device 140 determines that the received recommendation does not indicate that the content should be blocked from being posted online, the method 700 advances to block 712 in which the computing device 140 presents the received recommendation to the user (e.g., displays the received recommendation to the user via an associated display device). If, however, the computing device 140 determines instead that the received recommendation indicates that the content should be blocked from being posted online, the method 700 advances to block 710 in which the computing device 140 blocks (e.g., prevents, stops, etc.) the content from being posted online (e.g., transmitted to the online service provider(s) 130). To do so, in some embodiments, the computing device 140 may discard (e.g., drop, delete, erase, etc.) the communication message including the content blocked from being posted online.

In some embodiments, the process of analyzing content to be posted online and generating recommendations therefrom (e.g., the method 600) may be executed on the computing device 140 itself, rather than on the goal achievement server 110. That is, the computing device 140 may analyze the information to be posted online based on one or more goals and associated hindering/supporting conditions stored on the computing device 140. In such embodiments, the computing device 140 may determine/generate the one or more recommendations related to the content and, as a function of those recommendations, may take one or more actions in response (e.g., the method 700). For example, the computing device 140 may block the content from being posted online and/or present the recommendations to the user (e.g., blocks 708-712).

### EXAMPLES

Illustrative examples of the technologies disclosed herein are provided below. An embodiment of the technologies may include any one or more, and any combination of, the examples described below.

Example 1 includes a goal achievement computing device to electronically monitor achievement of goals, the goal achievement computing device including a goal selection module to receive a selection of a goal from a plurality of goals to be achieved by a user, each goal being related to an online presence of the user; an online content indexing module to index online content related to the selected goal; and a goal management module to: (i) analyze the indexed online content based on a goal database, the goal database including at least one of (a) one or more hindering conditions that hinder achievement of the selected goal or (b) one or more supporting conditions that support achievement of the selected goal, and (ii) determine a recommendation for achievement of the selected goal based on a determination that at least a portion of the indexed online content satisfies at least one of the hindering conditions or the supporting conditions of the selected goal.

Example 2 includes the subject matter of Example 1, and wherein to index online content includes to retrieve social media content related to the selected goal. Example 3 includes the subject matter of any of Examples 1 and 2, and wherein the social media content includes at least one of a social networking post, a social networking comment, or a social networking chat message.

Example 4 includes the subject matter of any of Examples 1-3, and wherein to index online content includes to retrieve web content related to the selected goal.

Example 5 includes the subject matter of any of Examples 1-4, and wherein the web content includes at least one of textual content, visual content, or aural content associated with one or more web pages.

Example 6 includes the subject matter of any of Examples 1-5, and wherein to analyze the indexed online content based on the goal database includes to compare the indexed online content to the goal database to determine whether the indexed online content satisfies at least one of the hindering conditions or the supporting conditions of the selected goal.

Example 7 includes the subject matter of any of Examples 1-6, and wherein the one or more hindering conditions of the selected goal include one or more hindering keywords that hinder achievement of the selected goal.

Example 8 includes the subject matter of any of Examples 1-7, and wherein the one or more supporting conditions of the selected goal include one or more supporting keywords that facilitate achievement of the selected goal.

Example 9 includes the subject matter of any of Examples 1-8, and wherein the goal database further includes a recommendation corresponding to each hindering condition of the selected goal; wherein to determine the recommendation includes determine the recommendation for achievement of the selected goal based on a determination that at least a portion of the indexed online content satisfies a hindering condition of the one or more hindering conditions; and wherein the goal management module is further to retrieve the recommendation that corresponds to the satisfied hindering condition.

Example 10 includes the subject matter of any of Examples 1-9, and wherein the goal database further includes a recommendation corresponding to each supporting condition of the selected goal; wherein to determine the recommendation includes determine the recommendation for achievement of the selected goal based on a determination that at least a portion of the indexed online content satisfies a supporting condition of the one or more supporting conditions; and wherein the goal management module is further to retrieve the recommendation that corresponds to the satisfied supporting condition.

Example 11 includes the subject matter of any of Examples 1-10, and wherein to determine the recommendation includes to: (i) determine content that facilitates achievement of the selected goal; and (ii) generate a recommendation that the determined content be posted online to facilitate achievement of the selected goal.

Example 12 includes the subject matter of any of Examples 1-11, and wherein to determine the recommendation includes to: (i) determine at least a portion of the indexed online content that hinders achievement of the selected goal; and (ii) generate a recommendation that the determined portion of the indexed online content be taken offline to facilitate achievement of the selected goal.

Example 13 includes the subject matter of any of Examples 1-12, and wherein to determine the recommendation includes to: (i) determine at least a portion of the indexed online content that hinders achievement of the selected goal; and (ii) generate a recommendation that the determined portion of the indexed online content be revised to facilitate achievement of the selected goal.

Example 14 includes the subject matter of any of Examples 1-13, and wherein the goal management module is further to: (i) analyze content to be posted online based on the selected goal; and (ii) determine another recommendation for achievement of the selected goal based on a determination that the analyzed content satisfies at least one of the hindering conditions or the supporting conditions of the selected goal.

Example 15 includes the subject matter of any of Examples 1-14, and wherein to analyze the content to be posed online based on the selected goal includes to compare the analyzed content to the goal database to determine whether the analyzed content satisfies at least one of the hindering conditions or the supporting conditions of the selected goal.

Example 16 includes the subject matter of any of Examples 1-15, and wherein to determine the another recommendation for achievement of the selected goal includes to: (i) determine whether the analyzed content facilitates achievement of the selected goal; and (ii) generate a recommendation that the analyzed content be posted online in response to a determination that the analyzed content facilitates achievement of the selected goal.

Example 17 includes the subject matter of any of Examples 1-16, and wherein to determine the another recommendation for achievement of the selected goal includes to: (i) determine whether at least a portion of the analyzed content hinders achievement of the selected goal; and (ii) generate a recommendation that the determined portion of the analyzed content be at least one of revised or removed in response to a determination that the portion of the analyzed content hinders achievement of the selected goal.

Example 18 includes the subject matter of any of Examples 1-17, and wherein to determine the another recommendation for achievement of the selected goal includes to: (i) determine whether the analyzed content hinders achievement of the selected goal; and (ii) generate a recommendation that the analyzed content be blocked from being posted online in response to a determination that the analyzed content hinders achievement of the selected goal.

Example 19 includes the subject matter of any of Examples 1-18, and wherein the goal management module is further to: (i) receive the content to be posted online from a computing device of the user; and (ii) transmit the another recommendation to the computing device of the user.

Example 20 includes the subject matter of any of Examples 1-19, and wherein the goal database further includes a reference recommendation for achievement of the selected goal, the reference recommendation associated with an online activity that facilitates achievement of the selected goal; and wherein the goal management module is further to: (i) retrieve the reference recommendation from the goal database, and (ii) transmit the reference recommendation to a computing device of the user.

Example 21 includes the subject matter of any of Examples 1-20, and wherein the online content monitoring module is further to receive a selection of another goal from the plurality of goals to be achieved by the user; wherein to index online content includes to index online content related to the selected goal and the selected another goal; wherein to analyze the indexed online content based on the goal database includes to analyze the indexed online content related to the selected goal and the selected another goal based on the goal database, the goal database further including at least one of (i) one or more hindering conditions that hinder achievement of the selected another goal or (ii) one or more supporting conditions that support achievement of the selected another goal; and wherein to determine the recommendation includes to determine a recommendation for achievement of the selected goal and the selected another goal based on a determination that at least a portion of the indexed online content (i) satisfies at least one of the hindering conditions or the supporting conditions of the selected goal and (ii) satisfies at least one of the hindering conditions or the supporting conditions of the selected another goal.

Example 22 includes a method for electronically monitoring achievement of goals, the method including receiving, by a goal achievement computing device, a selection of a goal from a plurality of goals to be achieved by a user, each goal being related to an online presence of the user; indexing, by the goal achievement computing device, online content related to the selected goal; analyzing, by the goal achievement computing device, the indexed online content based on a goal database, the goal database including at least one of (i) one or more hindering conditions that hinder achievement of the selected goal or (ii) one or more supporting conditions that support achievement of the selected goal; and determining, by the goal achievement computing device, a recommendation for achieving the selected goal based on a determination that at least a portion of the indexed online content satisfies at least one of the hindering conditions or the supporting conditions of the selected goal.

Example 23 includes the subject matter of Example 22, and wherein indexing online content includes retrieving social media content related to the selected goal.

Example 24 includes the subject matter of any of Examples 22 and 23, and wherein the social media content includes at least one of a social networking post, a social networking comment, or a social networking chat message.

Example 25 includes the subject matter of any of Examples 22-24, and wherein indexing online content includes retrieving web content related to the selected goal.

Example 26 includes the subject matter of any of Examples 22-25, and wherein the web content includes at least one of textual content, visual content, or aural content associated with one or more web pages.

Example 27 includes the subject matter of any of Examples 22-26, and wherein analyzing the indexed online content based on the goal database includes comparing the indexed online content to the goal database to determine whether the indexed online content satisfies at least one of the hindering conditions or the supporting conditions of the selected goal.

Example 28 includes the subject matter of any of Examples 22-27, and wherein the one or more hindering conditions of the selected goal include one or more hindering keywords that hinder achievement of the selected goal.

Example 29 includes the subject matter of any of Examples 22-28, and wherein the one or more supporting conditions of the selected goal include one or more supporting keywords that facilitate achievement of the selected goal.

Example 30 includes the subject matter of any of Examples 22-29, and wherein the goal database further includes a recommendation corresponding to each hindering condition of the selected goal; wherein determining the recommendation includes determining the recommendation for achievement of the selected goal based on a determination that at least a portion of the indexed online content satisfies a hindering condition of the one or more hindering conditions; and further includes retrieving the recommendation corresponding to the satisfied hindering condition.

Example 31 includes the subject matter of any of Examples 22-30, and wherein the goal database further includes a recommendation corresponding to each supporting condition of the selected goal; wherein determining the recommendation includes determining the recommendation for achievement of the selected goal based on a determination that at least a portion of the indexed online content satisfies a supporting condition of the one or more supporting conditions; and further includes retrieving the recommendation corresponding to the satisfied supporting condition.

Example 32 includes the subject matter of any of Examples 22-31, and wherein determining the recommendation includes: (i) determining content that facilitates achievement of the selected goal; and (ii) generating a recommendation that the determined content be posted online to facilitate achieving the selected goal.

Example 33 includes the subject matter of any of Examples 22-32, and wherein determining the recommendation includes: (i) determining at least a portion of the indexed online content that hinders achievement of the selected goal; and (ii) generating a recommendation that the determined portion of the indexed online content be taken offline to facilitate achieving the selected goal.

Example 34 includes the subject matter of any of Examples 22-33, and wherein determining the recommendation includes: (i) determining at least a portion of the indexed online content that hinders achievement of the selected goal; and (ii) generating a recommendation that the determined portion of the indexed online content be revised to facilitate achieving the selected goal.

Example 35 includes the subject matter of any of Examples 22-34, and further including analyzing, by the goal achievement computing device, content to be posted online based on the selected goal; and determining, by the goal achievement computing device, another recommendation for achieving the selected goal based on a determination that the analyzed content satisfies at least one of the hindering conditions or the supporting conditions of the selected goal.

Example 36 includes the subject matter of any of Examples 22-35, and wherein analyzing the content to be posted online based on the selected goal includes comparing the analyzed content to the goal database to determine whether the analyzed content satisfies at least one of the hindering conditions or the supporting conditions of the selected goal.

Example 37 includes the subject matter of any of Examples 22-36, and wherein determining the another recommendation for achieving the selected goal includes: (i) determining whether the analyzed content facilitates achievement of the selected goal; and (ii) generating a recommendation that the analyzed content be posted online in response to a determination that the analyzed content facilitates achievement of the selected goal.

Example 38 includes the subject matter of any of Examples 22-37, and wherein determining the another recommendation for achieving the selected goal includes: (i) determining whether at least a portion of the analyzed content hinders achievement of the selected goal; and (ii) generating a recommendation that the determined portion of the analyzed content be at least one of revised or removed in response to a determination that the portion of the analyzed content hinders achievement of the selected goal.

Example 39 includes the subject matter of any of Examples 22-38, and wherein determining the another recommendation for achieving the selected goal includes: (i) determining whether the analyzed content hinders achievement of the selected goal; and (ii) generating a recommendation that the analyzed content be blocked from being posted online in response to a determination that the analyzed content hinders achievement of the selected goal.

Example 40 includes the subject matter of any of Examples 22-39, and further including receiving, by the goal achievement computing device, the content to be posted online from a computing device of the user; and transmitting, by the goal achievement computing device, the another recommendation to the computing device of the user.

Example 41 includes the subject matter of any of Examples 22-40, and wherein the goal database further includes a reference recommendation for achievement of the selected goal, the reference recommendation associated with an online activity that facilitates achievement of the selected goal; and further including retrieving, by the goal achievement computing device, the reference recommendation from the goal database, and transmitting, by the goal achievement computing device, the reference recommendation to a computing device of the user.

Example 42 includes the subject matter of any of Examples 22-41, and further including receiving, by the goal achievement computing device, a selection of another goal from the plurality of goals to be achieved by the user; wherein indexing online content includes indexing online content related to the selected goal and the selected another goal; wherein analyzing the indexed online content based on the goal database includes analyzing the indexed online content related to the selected goal and the selected another goal based on the goal database, the goal database further including at least one of (i) one or more hindering conditions that hinder achievement of the selected another goal or (ii) one or more supporting conditions that support achievement of the selected another goal; and wherein determining the recommendation includes determining a recommendation for achieving the selected goal and the selected another goal based on a determination that at least a portion of the indexed online content (i) satisfies at least one of the hindering conditions or the supporting conditions of the selected goal and (ii) satisfies at least one of the hindering conditions or the supporting conditions of the selected another goal.

Example 43 includes a goal achievement computing device to electronically monitor achievement of goals, the goal achievement computing device including a processor; and a memory having stored therein a plurality of instructions that when executed by the processor cause the goal achievement computing device to perform the method of any of Examples 22-42.

Example 44 includes one or more machine-readable media including a plurality of instructions stored thereon that in response to being executed result in a goal achievement computing device performing the method of any of Examples 22-42.

Example 45 includes a goal achievement computing device to electronically monitor achievement of goals, the goal achievement computing device including means for performing the method of any of Examples 22-42.

Example 46 includes a computing device to electronically monitor content to be posted online, the computing device including a content monitoring module to transmit content to be posted online to a goal achievement computing device; and a goal management module to: (i) select a goal from a plurality of goals provided by the goal achievement computing device, each goal to be achieved by a user and is related to an online presence of the user; (ii) receive a recommendation from the goal achievement computing device, the recommendation is associated with the content to be posted online and is based on the selected goal; (iii) determine whether the received recommendation indicates that the content should be blocked from being posted online; and (iv) block the content from being posted online in response to a determination that the received recommendation indicates that the content should be blocked from being posted online.

Example 47 includes the subject matter of Example 46, and wherein the goal management module is further to present the received recommendation to the user in response to a determination that the received recommendation does not indicate that the content should be blocked from being posted online.

Example 48 includes the subject matter of any of Examples 46 and 47, and wherein the content to be posted online includes at least one of a social networking post, a social networking comment, a social networking chat message.

Example 49 includes the subject matter of any of Examples 46-48, and wherein the content to be posted online includes at least one of textual content, visual content, or aural content to be posted on one or more web pages.

Example 50 includes the subject matter of any of Examples 46-49, and wherein the goal management module is further to: (i) receive a reference recommendation from the goal achievement computing device, the reference recommendation is associated with an online activity that facilitates achievement of the selected goal; and (ii) present the received reference recommendation to the user.

Example 51 includes a method for electronically monitoring content to be posted online, the method including selecting, by a computing device, a goal from a plurality of goals provided by a goal achievement computing device, each goal to be achieved by a user and is related to an online presence of the user; transmitting, by the computing device, content to be posted online to the goal achievement computing device; receiving, by the computing device, a recommendation (i) associated with the content and (ii) based on the selected goal from the goal achievement computing device; determining, by the computing device, whether the received recommendation indicates that the content should be blocked from being posted online; and blocking, by the computing device, the content from being posted online in response to a determination that the received recommendation indicates that the content should be blocked from being posted online.

Example 52 includes the subject matter of Example 51, and further including presenting, by the computing device, the received recommendation to the user in response to a determination that the received recommendation does not indicate that the content should be blocked from being posted online.

Example 53 includes the subject matter of any of Examples 51 and 52, and wherein the content to be posted online includes at least one of a social networking post, a social networking comment, a social networking chat message.

Example 54 includes the subject matter of any of Examples 51-53, and wherein the content to be posted online includes at least one of textual content, visual content, or aural content to be posted on one or more web pages.

Example 55 includes the subject matter of any of Examples 51-54, and further including receiving, by the computing device, a reference recommendation from the goal achievement computing device, the reference recommendation is associated with an online activity that facilitates achievement of the selected goal; and presenting, by the computing device, the received reference recommendation to the user.

Example 56 includes a computing device to electronically monitor content to be posted online, the computing device including a processor; and a memory having stored therein a plurality of instructions that when executed by the processor cause the computing device to perform the method of any of Examples 51-55.

Example 57 includes one or more machine-readable media including a plurality of instructions stored thereon that in response to being executed result in a computing device performing the method of any of Examples 51-55.

Example 58 includes a computing device to electronically monitor content to be posted online, the computing device including means for performing the method of any of Examples 51-55.

1-25. (canceled)

26. A goal achievement computing device to electronically monitor achievement of goals, the goal achievement computing device comprising:
a goal selection module to receive a selection of a goal from a plurality of goals to be achieved by a user, each goal being related to an online presence of the user;
an online content indexing module to index online content related to the selected goal; and
a goal management module to: (i) analyze the indexed online content based on a goal database, the goal database comprising at least one of (a) one or more hindering conditions that hinder achievement of the selected goal or (b) one or more supporting conditions that support achievement of the selected goal, and (ii) determine a recommendation for achievement of the selected goal based on a determination that at least a portion of the indexed online content satisfies at least one of the hindering conditions or the supporting conditions of the selected goal.

27. The goal achievement computing device of claim 26, wherein to index online content comprises to at least one of (i) retrieve social media content related to the selected goal or (ii) retrieve web content related to the selected goal.

28. The goal achievement computing device of claim 26, wherein to analyze the indexed online content based on the goal database comprises to compare the indexed online content to the goal database to determine whether the indexed online content satisfies at least one of the hindering conditions or the supporting conditions of the selected goal.

29. The goal achievement computing device of claim 26, wherein the one or more hindering conditions of the selected goal comprise one or more hindering keywords that hinder achievement of the selected goal.

30. The goal achievement computing device of claim 26, wherein the one or more supporting conditions of the selected goal comprise one or more supporting keywords that facilitate achievement of the selected goal.

31. The goal achievement computing device of claim 26, wherein the goal database further comprises a recommendation corresponding to each hindering condition of the selected goal;
wherein to determine the recommendation comprises determine the recommendation for achievement of the selected goal based on a determination that at least a portion of the indexed online content satisfies a hindering condition of the one or more hindering conditions; and
wherein the goal management module is further to retrieve the recommendation that corresponds to the satisfied hindering condition.

32. The goal achievement computing device of claim 26, wherein the goal database further comprises a recommendation corresponding to each supporting condition of the selected goal;
wherein to determine the recommendation comprises determine the recommendation for achievement of the selected goal based on a determination that at least a portion of the indexed online content satisfies a supporting condition of the one or more supporting conditions; and
wherein the goal management module is further to retrieve the recommendation that corresponds to the satisfied supporting condition.

33. The goal achievement computing device of claim 26, wherein to determine the recommendation comprises to: (i) determine content that facilitates achievement of the selected goal; and (ii) generate a recommendation that the determined content be posted online to facilitate achievement of the selected goal.

34. The goal achievement computing device of claim 26, wherein to determine the recommendation comprises to: (i) determine at least a portion of the indexed online content that hinders achievement of the selected goal; and (ii) at least one of (a) generate a recommendation that the determined portion of the indexed online content be taken offline to facilitate achievement of the selected goal or (b) generate a recommendation that the determined portion of the indexed online content be revised to facilitate achievement of the selected goal.

35. The goal achievement computing device of claim 26, wherein the goal management module is further to: (i) analyze content to posed online based on the selected goal; and (ii) determine another recommendation for achievement of the selected goal based on a determination that the analyzed content satisfies at least one of the hindering conditions or the supporting conditions of the selected goal.

36. The goal achievement computing device of claim 35, wherein to analyze the content to be posted online based on the selected goal comprises to compare the analyzed content to the goal database to determine whether the analyzed content satisfies at least one of the hindering conditions or the supporting conditions of the selected goal.

37. The goal achievement computing device of claim 35, wherein to determine the another recommendation for achievement of the selected goal comprises to: (i) determine whether the analyzed content facilitates achievement of the selected goal; and (ii) generate a recommendation that the analyzed content be posted online in response to a determination that the analyzed content facilitates achievement of the selected goal.

38. The goal achievement computing device of claim 35, wherein to determine the another recommendation for achievement of the selected goal comprises to: (i) determine whether at least a portion of the analyzed content hinders achievement of the selected goal; and (ii) generate a recommendation that the determined portion of the analyzed content be at least one of: (a) revised, (b) removed, or (c) blocked from being posted online in response to a determination that the portion of the analyzed content hinders achievement of the selected goal.

39. The goal achievement computing device of claim 35, wherein the goal management module is further to: (i) receive the content to be posted online from a computing device of the user; and (ii) transmit the another recommendation to the computing device of the user.

40. The goal achievement computing device of claim 26, wherein the goal database further comprises a reference recommendation for achievement of the selected goal, the reference recommendation associated with an online activity that facilitates achievement of the selected goal; and
wherein the goal management module is further to: (i) retrieve the reference recommendation from the goal database, and (ii) transmit the reference recommendation to a computing device of the user.

41. The goal achievement computing device of claim 26, wherein the online content monitoring module is further to receive a selection of another goal from the plurality of goals to be achieved by the user;
wherein to index online content comprises to index online content related to the selected goal and the selected another goal;
wherein to analyze the indexed online content based on the goal database comprises to analyze the indexed online content related to the selected goal and the selected another goal based on the goal database, the goal database further comprising at least one of (i) one or more hindering conditions that hinder achievement of the selected another goal or (ii) one or more supporting conditions that support achievement of the selected another goal; and
wherein to determine the recommendation comprises to determine a recommendation for achievement of the selected goal and the selected another goal based on a determination that at least a portion of the indexed online content (i) satisfies at least one of the hindering conditions or the supporting conditions of the selected goal and (ii) satisfies at least one of the hindering conditions or the supporting conditions of the selected another goal.

42. One or more machine-readable media comprising a plurality of instructions stored thereon that in response to being executed by a goal achievement computing device, cause the goal achievement computing device to:
receive a selection of a goal from a plurality of goals to be achieved by a user, each goal being related to an online presence of the user;
index online content related to the selected goal;
analyze the indexed online content based on a goal database, the goal database comprising at least one of (i) one or more hindering conditions that hinder achievement of the selected goal or (ii) one or more supporting conditions that support achievement of the selected goal; and
determine a recommendation for achievement of the selected goal based on a determination that at least a portion of the indexed online content satisfies at least one of the hindering conditions or the supporting conditions of the selected goal.

43. The one or more machine-readable media of claim 42, wherein the goal database further comprises a recommendation that corresponds to each hindering condition of the selected goal;
wherein to determine the recommendation comprises to determine the recommendation for achievement of the selected goal based on a determination that at least a portion of the indexed online content satisfies a hindering condition of the one or more hindering conditions; and
wherein the plurality of instructions further cause the goal achievement computing device to retrieve the recommendation that corresponds to the satisfied hindering condition.

44. The one or more machine-readable media of claim 42, wherein the goal database further comprises a recommendation that corresponds to each supporting condition of the selected goal;
wherein to determine the recommendation comprises to determine the recommendation for achievement of the selected goal based on a determination that at least a portion of the indexed online content satisfies a supporting condition of the one or more supporting conditions; and
wherein the plurality of instructions further cause the goal achievement computing device to retrieve the recommendation that corresponds to the satisfied supporting condition.

45. The one or more machine-readable media of claim 42, wherein to determine the recommendation comprises to at least one of (i) determine content that facilitates achievement of the selected goal, and generate a recommendation that the determined content be posted online to facilitate achieving the selected goal or (ii) determine at least a portion of the indexed online content that hinders achievement of the selected goal, and at least one of (a) generate a recommendation that the determined portion of the indexed online content be taken offline to facilitate achievement of the selected goal or (b) generate a recommendation that the determined portion of the indexed online content be revised to facilitate achievement of the selected goal.

46. The one or more machine-readable media of claim 42, wherein the plurality of instructions further cause the goal achievement computing device to:
analyze content to be posted online based on the selected goal; and
determine another recommendation for achievement of the selected goal based on a determination that the analyzed content satisfies at least one of the hindering conditions or the supporting conditions of the selected goal.

47. The one or more machine-readable media of claim 46, wherein to determine the another recommendation for achievement of the selected goal comprises to: (i) determine whether the analyzed content facilitates achievement of the selected goal; and (ii) generate a recommendation that the analyzed content be posted online in response to a determination that the analyzed content facilitates achievement of the selected goal.

48. The one or more machine-readable media of claim 46, wherein to determine the another recommendation for achieving the selected goal comprises to: (i) determine whether at least a portion of the analyzed content hinders achievement of the selected goal; and (ii) generate a recommendation that the determined portion of the analyzed content be at least one of: (a) revised, (b) removed, or (c) blocked from being posted online in response to a determination that the portion of the analyzed content hinders achievement of the selected goal.

49. A method for electronically monitoring achievement of goals, the method comprising:
receiving, by a goal achievement computing device, a selection of a goal from a plurality of goals to be achieved by a user, each goal being related to an online presence of the user;
indexing, by the goal achievement computing device, online content related to the selected goal;
analyzing, by the goal achievement computing device, the indexed online content based on a goal database, the goal database comprising at least one of (i) one or more hindering conditions that hinder achievement of the selected goal or (ii) one or more supporting conditions that support achievement of the selected goal; and
determining, by the goal achievement computing device, a recommendation for achieving the selected goal based on a determination that at least a portion of the indexed online content satisfies at least one of the hindering conditions or the supporting conditions of the selected goal.

50. The method of claim 49, wherein determining the recommendation comprises at least one of (i) determining content that facilitates achievement of the selected goal, and generating a recommendation that the determined content be posted online to facilitate achieving the selected goal or (ii) determining at least a portion of the indexed online content that hinders achievement of the selected goal, and at least one of (a) generating a recommendation that the determined portion of the indexed online content be taken offline to facilitate achieving the selected goal or (b) generating a recommendation that the determined portion of the indexed online content be revised to facilitate achieving the selected goal.
